(19) United States
(12) Patent Application Publication
(10) Pub. No.: US 2018/0134023 A1
(43) Pub. Date: May 17, 2018

(54) VACUUM LAMINATION DEVICE AND METHOD FOR LAMINATING FINGERPRINT RECOGNITION MODULE UNDER VACUUM CONDITION

(71) Applicant: Primax Electronics Ltd., Taipei (TW)

(72) Inventor: Tsung-Yi Lu, Taiwan (TW)

(21) Appl. No.: 15/790,380

(22) Filed: Oct. 23, 2017

Related U.S. Application Data
(60) Provisional application No. 62/422,488, filed on Nov. 15, 2016.

(51) Int. Cl. B32B 37/10; B32B 37/06; G06K 9/00

(52) U.S. Cl. CPC B32B 37/1018; G06K 9/00006; B32B 37/06

(57) ABSTRACT

A vacuum lamination device includes a top mold and a bottom mold. The top mold includes a laminating plate. The bottom mold includes a fixing recess. A method for laminating a fingerprint recognition module under a vacuum condition includes the following steps. In a step (a), the vacuum lamination device is provided. In a step (b), the fingerprint recognition module is placed into the fixing recess. In a step (c), the top mold is moved toward the bottom mold to define a sealed chamber. In a step (d), the sealed chamber is evacuated to be in a vacuum state. Consequently, the laminating plate of is subjected to deformation to press a covering plate of the fingerprint recognition module. In a step (e), the fingerprint recognition module in the vacuum lamination device is baked.

### FIELD OF THE INVENTION

The present invention relates to a vacuum lamination method, and more particularly to a method for laminating a fingerprint recognition module under a vacuum condition.

### BACKGROUND OF THE INVENTION

With increasing development of science and technology, mobile electronic devices or notebook computers become essential devices to people. For facilitating the mobile electronic devices or the notebook computers to safely recognize the users' identities, a fingerprint recognition technology is one of the widely-used biometric recognition technologies. In addition, the fingerprint recognition technology is gradually applied to various electronic devices that are popular to most users.

Nowadays, a fingerprint recognition module is gradually used. A covering plate is the outermost layer of the fingerprint recognition module. Consequently, the covering plate can be touched and pressed by the user's finger. For fabricating the fingerprint recognition module, the covering plate is attached on a fingerprint chip by a machine. The covering plate and the fingerprint chip are combined together through a glue. If the process of laminating the covering plate on the fingerprint chip is performed under a general working environment, bubbles are usually generated in the glue. The bubbles may obviously influence the recognized contents of the fingerprint recognition module. Since the bubbles are generated in the region between the covering plate and the fingerprint chip, the image quality detected by the fingerprint recognition module is impaired and the detecting precision is reduced. For solving the above drawbacks, it is necessary to perform a process of removing bubbles. As known, the bubble-removing process is time-consuming and labor-intensive. Moreover, the bubble-removing process cannot effectively remove the bubbles. In other words, the method of fabricating the fingerprint recognition module needs to be further improved.

### SUMMARY OF THE INVENTION

The present invention provides a vacuum lamination device and a method for laminating a fingerprint recognition module under a vacuum condition. When a vacuum condition is created in the vacuum lamination device, the fingerprint recognition module is laminated and baked to cure under the vacuum condition. Since no bubbles are generated in the glue between the covering plate and the fingerprint recognition module, the detecting precision of the fingerprint recognition module is maintained in a good condition.

In accordance with an aspect of the present invention, there is provided a method for laminating a fingerprint recognition module under a vacuum condition. The method includes the following steps. In a step (a), a vacuum lamination device including a top mold and a bottom mold is provided. The top mold is movable relative to the bottom mold. The top mold includes a laminating plate. The bottom mold includes a fixing recess corresponding to the laminating plate. In a step (b), a fingerprint recognition module is placed in the fixing recess. The fingerprint recognition module includes a fingerprint chip, a glue and a covering plate. The glue is arranged between the covering plate and the fingerprint chip. In a step (c), the top mold is moved toward the bottom mold. When the top mold and the bottom mold are contacted with each other, a sealed chamber is defined by the top mold and the bottom mold collaboratively. In a step (d), a gas within the sealed chamber is evacuated, so that the sealed chamber is in a vacuum state. The laminating plate is subjected to downward deformation in response to the vacuum state, so that the covering plate of the fingerprint recognition module is pressed by the laminating plate. In a step (e), the fingerprint recognition module in the vacuum lamination device is baked.

In an embodiment, the laminating plate includes a laminating foam structure, and the bottom mold further includes at least one gas channel and a vacuum valve. The laminating foam structure is attached on a bottom surface of the laminating plate and aligned with the fixing recess. The sealed chamber is in communication with the at least one gas channel and the vacuum valve. The step (d) includes the following steps. In a step (d1), the vacuum valve is opened, and the gas within the sealed chamber is evacuated through the at least one gas channel. In response to a pressure difference between an external pressure and an inner pressure, the laminating plate is subjected to deformation to press the bottom mold, and the laminating foam structure is moved downwardly to press the covering plate of the fingerprint recognition module. In a step (d2), the vacuum valve is closed when the sealed chamber reaches the vacuum state.

In an embodiment, the step (e) includes a step (e1) of maintaining the vacuum state of the sealed chamber and allowing the fingerprint recognition module in the vacuum lamination device to be baked, so that the glue is cured.

In an embodiment, after the step (e), the method further includes a step (f) of removing the fingerprint recognition module from the fixing recess of the vacuum lamination device.

In an embodiment, before the step (b), the method further includes a step (b′) of sequentially coating the glue on a top surface of the fingerprint chip and placing the covering plate on the glue.

In an embodiment, the covering plate is made of a ceramic material or a glass material.

In accordance with another aspect of the present invention, there is provided a vacuum lamination device for laminating a fingerprint recognition module. The vacuum lamination device includes a top mold and a bottom mold. The top mold includes a top mold plate and a laminating plate. The laminating plate is connected with the top mold plate. The bottom mold is movable relative to the top mold. The bottom mold includes a bottom mold structure, a fixing recess, at least one gas channel and a vacuum valve. The fixing recess is concavely formed in a portion of a top surface of the bottom mold structure for accommodating the fingerprint recognition module. The at least one gas channel is formed downwardly from another portion of the top surface of the bottom mold structure and in communication with the vacuum valve. When the top mold and the bottom mold are contacted with each other, a sealed chamber is defined by the top mold and the bottom mold collaboratively, and the sealed chamber is in communication with the vacuum valve through the at least one gas channel.

In an embodiment, the laminating plate further includes a laminating foam structure, and the laminating foam structure is formed on a bottom surface of the laminating plate and aligned with the fixing recess. When the top mold and the bottom mold are contacted with each other and the sealed chamber is in a vacuum state, the laminating plate is subjected to downward deformation and the fingerprint recognition module within the fixing recess is pressed by the laminating foam structure.

In an embodiment, the fixing recess is concavely formed in a middle region of the top surface of the bottom mold structure, and the at least one gas channel includes plural gas channels. The plural gas channels are formed downwardly from a peripheral region of the top surface of the bottom mold structure. The plural gas channels are in communication with the vacuum valve. The vacuum valve is located at a lateral side of the bottom mold structure.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic cross-sectional view illustrating a vacuum lamination device according to an embodiment of the present invention, in which a fingerprint identification mode has not been placed in the vacuum lamination device;

FIG. 2 is a schematic cross-sectional view illustrating the vacuum lamination device according to the embodiment of the present invention, in which a fingerprint identification mode is placed in the vacuum lamination device;

FIG. 3 is a schematic cross-sectional view illustrating the vacuum lamination device according to the embodiment of the present invention, in which the top mold and the bottom mold are contacted with each other to define a sealed chamber;

FIG. 4 is a schematic cross-sectional view illustrating the vacuum lamination device according to the embodiment of the present invention, in which the air in the sealed chamber of the vacuum lamination device is evacuated;

FIG. 5 is a schematic cross-sectional view illustrating the vacuum lamination device according to the embodiment of the present invention, in which the sealed chamber is maintained in the vacuum state;

FIG. 6A is a first part of flowchart illustrating a method for laminating a fingerprint recognition module under a vacuum condition according to an embodiment of the present invention;

FIG. 6B is a second part of flowchart illustrating a method for laminating a fingerprint recognition module under a vacuum condition according to an embodiment of the present invention; and

FIG. 7 is a flowchart illustrating a step (b′) before the step (b) of the method for laminating the fingerprint recognition module according to the embodiment of the present invention.

### DETAILED DESCRIPTION OF THE PREFERRED EMBODIMENT

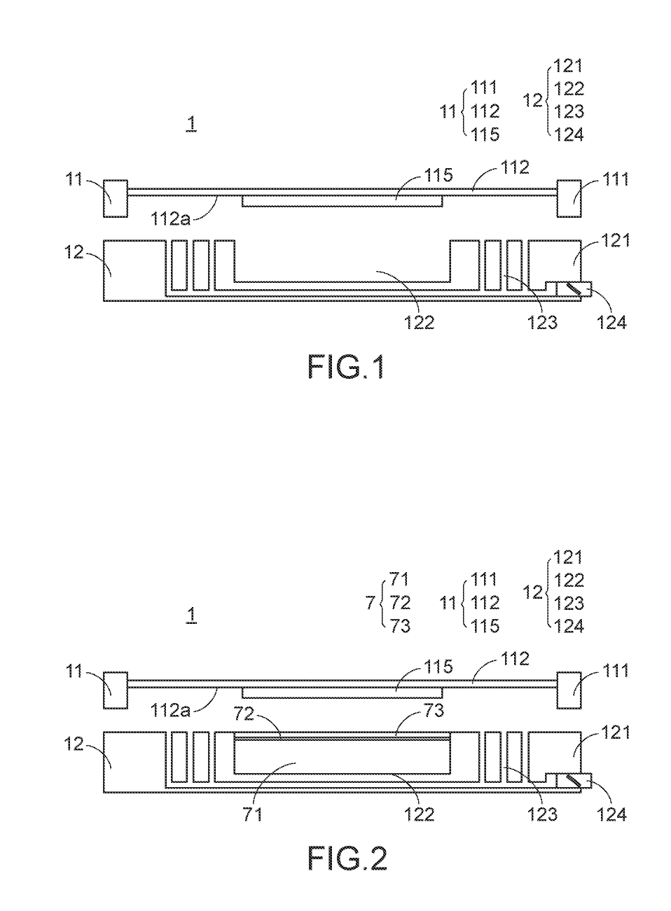

FIG. 1 is a schematic cross-sectional view illustrating a vacuum lamination device according to an embodiment of the present invention, in which a fingerprint identification mode has not been placed in the vacuum lamination device. As shown in FIG. 1, the vacuum lamination device 1 comprises a top mold 11 and a bottom mold 12. The top mold 11 and the bottom mold 12 are opposed to each other. Moreover, the top mold 11 and the bottom mold 12 are movable relative to each other. For example, as the top mold 11 is moved toward the bottom mold 12, the top mold 11 and the bottom mold 12 are combined together.

The top mold 11 comprises a top mold plate 11 and a laminating plate 112. Preferably, the periphery of the laminating plate 112 is connected with and fixed on the top mold plate 11. Consequently, while the top mold plate 11 is moved upwardly or downwardly, the laminating plate 112 is moved upwardly or downwardly with the top mold plate 11. The laminating plate 112 comprises a laminating foam structure 115. The laminating foam structure 115 is attached on a bottom surface 112a of the laminating plate 112. Moreover, the laminating foam structure 115 is aligned with a fixing recess 122 (see FIG. 2) of the bottom mold 12.

FIG. 2 is a schematic cross-sectional view illustrating the vacuum lamination device according to the embodiment of the present invention, in which a fingerprint identification mode is placed in the vacuum lamination device. As shown in FIG. 2, the bottom mold 12 comprises a bottom mold structure 121, the fixing recess 122, at least one gas channel 123 and a vacuum valve 124. The fixing recess 122 is concavely formed in a portion of a top surface of the bottom mold structure 121. Moreover, the fixing recess 122 is used for accommodating a fingerprint recognition module 7. Preferably, the fixing recess 122 is formed in a middle region of the top surface of the bottom mold structure 121. The at least one gas channel 123 is formed downwardly from another portion of the top surface of the bottom mold structure 121. Preferably, the at least one gas channel 123 comprises plural gas channels. These gas channels are formed on a peripheral region of the top surface of the bottom mold structure 121. The peripheral region is arranged around the middle region. The vacuum valve 124 is located at a converged end of the plural gas channels 123. Moreover, the vacuum valve 124 is in communication with the plural gas channels 123. By opening or closing the vacuum valve 124, the gas channels 123 are selectively in communication with the ambient gas. Preferably, the vacuum valve 124 is located at a lateral side of the bottom mold structure 121 and exposed outside.

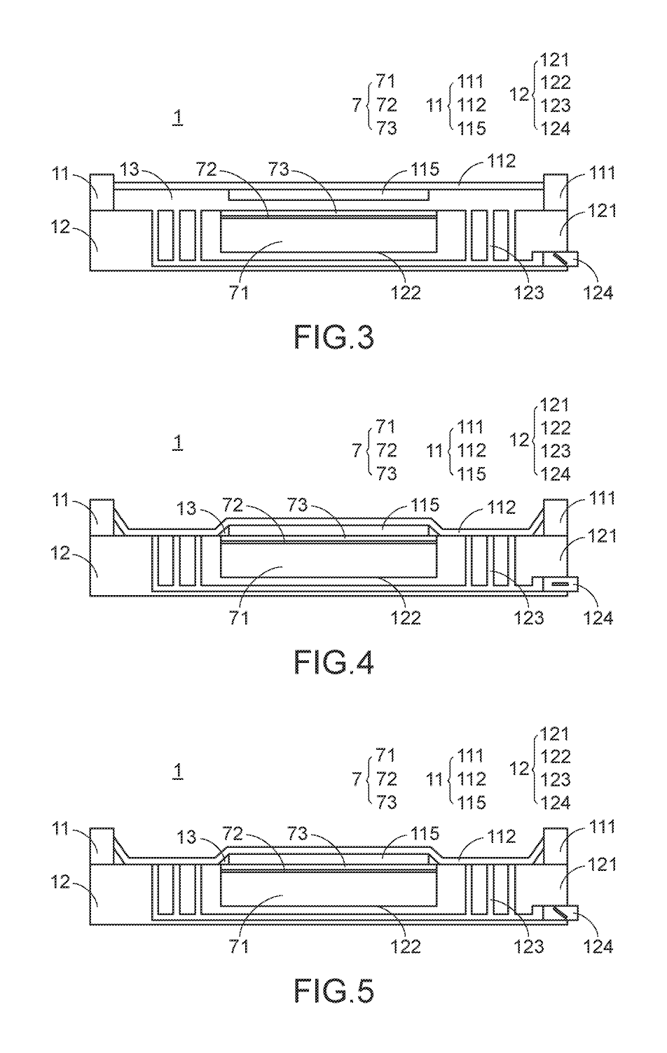

FIG. 3 is a schematic cross-sectional view illustrating the vacuum lamination device according to the embodiment of the present invention, in which the top mold and the bottom mold are contacted with each other to define a sealed chamber.

As mentioned above, the top mold 11 and the bottom mold 12 are combined together after the top mold 11 is moved toward the bottom mold 12. When the top mold 11 and the bottom mold 12 are contacted with each other, a sealed chamber 13 is defined by the top mold 11 and the bottom mold 12 collaboratively. Particularly, the sealed chamber 13 is defined by the top mold plate 11 and the laminating plate 112 of the top mold 11 and the bottom mold structure 121 of the bottom mold 12 collaboratively. The sealed chamber 13 is in communication with the vacuum valve 124 through the plural gas channels 123. Consequently, the gas within the sealed chamber 13 of the vacuum lamination device can be evacuated through the vacuum valve 124.

FIG. 4 is a schematic cross-sectional view illustrating the vacuum lamination device according to the embodiment of the present invention, in which the air in the sealed chamber of the vacuum lamination device is evacuated. After the contact between the top mold 11 and the bottom mold 12 are accomplished, the vacuum valve 124 is opened. Then, an evacuating machine (not shown) in the surroundings is turned on. After the sealed chamber 13 is evacuated by the evacuating machine through the vacuum valve 124 and the gas channels 123, the sealed chamber 13 is in a vacuum state. Since the external pressure of the surroundings is higher than the inner pressure of the sealed chamber 13, the laminating plate 112 is subjected to downward deformation in response to the pressure difference. At the same time, the laminating foam structure 115 on the bottom surface 112a of the laminating plate 112 is moved downwardly to press a covering plate 73 of the fingerprint recognition module 7. Consequently, the covering plate 73 is securely attached on a fingerprint chip 71 through a glue 72. Since the fingerprint recognition module 7 is laminated by the vacuum lamination device under a vacuum environment, no bubbles are generated in the glue 72 of the fingerprint recognition module 7 while the covering plate 73 is laminated toward the fingerprint chip 71.

FIG. 5 is a schematic cross-sectional view illustrating the vacuum lamination device according to the embodiment of the present invention, in which the sealed chamber is maintained in the vacuum state. As shown in FIG. 5, the vacuum valve 124 is closed. Consequently, the sealed chamber 13 of the vacuum lamination device 1 is maintained in the vacuum state. Then, the vacuum lamination device 1 with the fingerprint recognition module 7 is moved into an oven (not shown). Then, the fingerprint recognition module 7 in the vacuum state is baked by the oven.

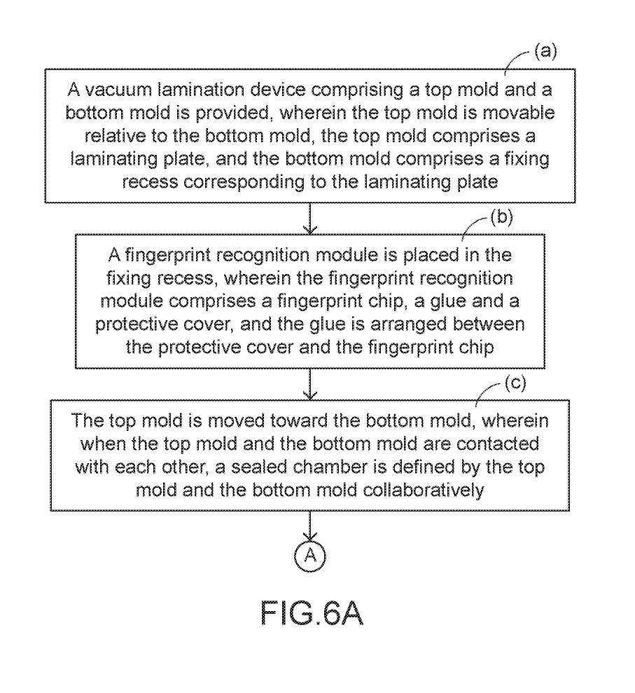

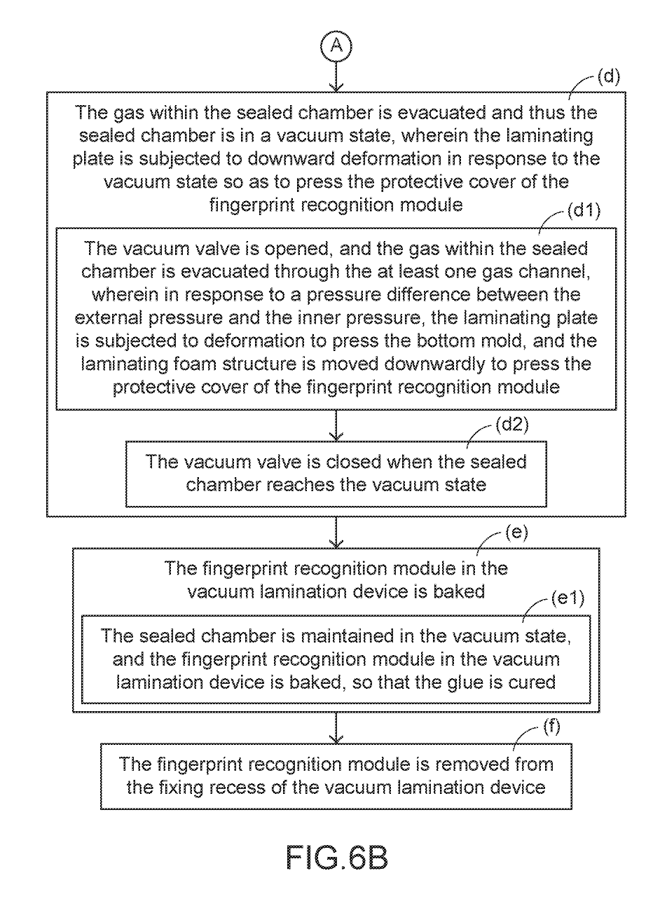

FIG. 6A is a first part of flowchart illustrating a method for laminating a fingerprint recognition module under a vacuum condition according to an embodiment of the present invention, and FIG. 6B is a second part of flowchart illustrating a method for laminating a fingerprint recognition module under a vacuum condition according to an embodiment of the present invention. The method comprises the following steps.

Firstly, in a step (a), a vacuum lamination device 1 is provided. The vacuum lamination device 1 comprises a top mold 11 and a bottom mold 12 (see FIG. 1). The top mold 11 is movable relative to the bottom mold 12. The top mold 11 comprises a top mold plate 11 and a laminating plate 112. A laminating foam structure 115 is attached on a bottom surface 112a of the laminating plate 112. The bottom mold 12 comprises a bottom mold structure 121, the fixing recess 122, at least one gas channel 123 and a vacuum valve 124. The detailed structures of the top mold 11 and the bottom mold 12 and the relationship between the top mold 11 and the bottom mold 12 are similar to those mentioned above, and are not redundantly described herein.

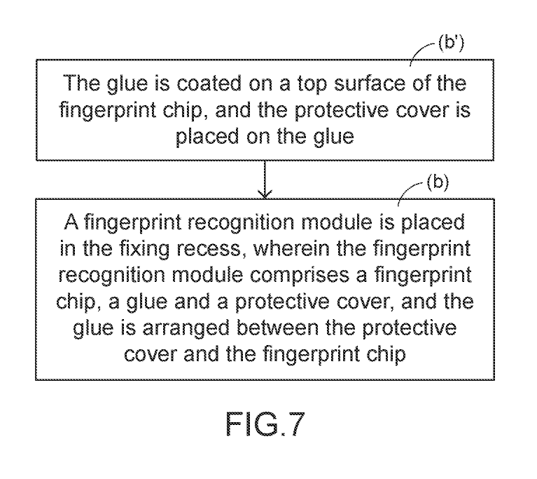

After the step (a), a step (b) is performed. Please also refer to FIG. 2. In the step (b), a fingerprint recognition module 7 is placed in the fixing recess 122. The fingerprint recognition module 7 comprises a fingerprint chip 71, a glue 72 and a covering plate 73. The glue 72 is arranged between the covering plate 73 and the fingerprint chip 71. Consequently, the covering plate 73 and the fingerprint chip 71 are combined together through the glue 72. FIG. 7 is a flowchart illustrating a step (b′) before the step (b) of the method for laminating the fingerprint recognition module according to the embodiment of the present invention. Before the step (b), the step (b′) is performed. In the step (b′), the glue 72 is coated on a top surface of the fingerprint chip 71, and the covering plate 72 is placed on the glue 72. Meanwhile, the glue 72 is not completely cured and has slight flowability. That is, the covering plate 73 and the fingerprint chip 71 are slightly adhered to each other and not securely combined together at this moment. In an embodiment, the covering plate 73 is made of a ceramic material or a glass material.

Then, a step (c) is performed. Please also refer to FIG. 3. In the step (c), the top mold 11 of the vacuum lamination device 1 is driven to be moved toward the bottom mold 12. When the top mold 11 and the bottom mold 12 are contacted with each other, a sealed chamber 13 is defined by the top mold 11 and the bottom mold 12 collaboratively and the fingerprint recognition module 7 is accommodated within the sealed chamber 13. Particularly, the sealed chamber 13 is defined by the top mold plate 11 of the top mold 11, the laminating plate 112 of the top mold and the bottom mold structure 121 of the bottom mold 12 collaboratively. That is, the fingerprint recognition module 7 fixed in the fixing recess 122 is also accommodated within the sealed chamber 13. The sealed chamber 13 is in communication with the vacuum valve 124 through the at least one gas channel 123. Consequently, the air within the sealed chamber 13 of the vacuum lamination device can be evacuated through the vacuum valve 124.

Then, a step (d) is performed. Please also refer to FIG. 4. In the step (d), the gas within the sealed chamber 13 is evacuated and thus the sealed chamber 13 is in a vacuum state. The laminating plate 112 is subjected to downward deformation in response to the vacuum state. At the same time, the laminating plate 112 is moved downwardly to press the covering plate 73 of the fingerprint recognition module 7. Consequently, the covering plate 73 is securely attached on a fingerprint chip 71 through the glue 72. Since the fingerprint recognition module 7 is laminated by the vacuum lamination device under a vacuum environment, no bubbles are generated in the glue 72 of the fingerprint recognition module 7 while the covering plate 73 is laminated toward the fingerprint chip 71.

The step (d) further comprises the steps (d1) and (d2). In the step (d1), the vacuum valve 124 is opened, and the gas within the sealed chamber 13 is evacuated by an evacuating machine (not shown) in the surroundings through the vacuum valve 124 and the at least one gas channel 123. In response to a pressure difference between the external pressure and the inner pressure, the laminating plate 112 is subjected to deformation to press the bottom mold 12. At the same time, the laminating foam structure 115 on the bottom surface 112a of the laminating plate 112 is moved downwardly to press the covering plate 73 of the fingerprint recognition module 7. After the step (d1), the step (d2) is performed. When the sealed chamber 13 reaches the vacuum state, the vacuum valve 124 is closed (see FIG. 5).

After the step (d), the glue 72 of the fingerprint recognition module 7 still has slight flowability. For forming the final product of the fingerprint recognition module 7, it is necessary to cure the glue 72 of the fingerprint recognition module 7.

After the step (d), a step (e) is performed. In the step (e), the fingerprint recognition module 7 in the vacuum lamination device 1 is baked. The step (e) further comprises a step (e1). In the step (e1), the sealed chamber 13 is maintained in the vacuum state and the fingerprint recognition module 7 in the vacuum lamination device 1 is baked. Consequently, the glue 72 is cured. In such a way, bubbles are not generated during the process of baking the fingerprint recognition module 7. The, a step (f) is performed. In the step (f), the fingerprint recognition module 7 is removed from the fixing recess 122 of the vacuum lamination device 1. Meanwhile, the final product of the fingerprint recognition module 7 that is laminated under the vacuum condition is obtained.

From the above descriptions, the present invention provides the method for laminating the fingerprint recognition module under a vacuum condition. While the covering plate is attached on the fingerprint chip, the fingerprint recognition module is in the vacuum state. Since no bubbles are generated in the glue between the covering plate and the fingerprint chip, the recognition precision of the fingerprint recognition module is not deteriorated. Moreover, according to the present invention, it is not necessary to additionally perform a process of removing bubbles. Since the fingerprint recognition module in the vacuum state is baked in the oven, no bubbles are generated in the glue of the fingerprint recognition module during the baking process. Consequently, the recognition precision of the fingerprint recognition module is also maintained.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A method for laminating a fingerprint recognition module under a vacuum condition, the method comprising steps of:
(a) providing a vacuum lamination device comprising a top mold and a bottom mold, wherein the top mold is movable relative to the bottom mold, the top mold comprises a laminating plate, and the bottom mold comprises a fixing recess corresponding to the laminating plate;
(b) placing a fingerprint recognition module in the fixing recess, wherein the fingerprint recognition module comprises a fingerprint chip, a glue and a covering plate, and the glue is arranged between the covering plate and the fingerprint chip;
(c) allowing the top mold to be moved toward the bottom mold, wherein when the top mold and the bottom mold are contacted with each other, a sealed chamber is defined by the top mold and the bottom mold collaboratively;
(d) evacuating a gas within the sealed chamber, so that the sealed chamber is in a vacuum state, wherein the laminating plate is subjected to downward deformation in response to the vacuum state, so that the covering plate of the fingerprint recognition module is pressed by the laminating plate; and
(e) allowing the fingerprint recognition module in the vacuum lamination device to be baked.

2. The method according to claim 1, wherein the laminating plate comprises a laminating foam structure, and the bottom mold further comprises at least one gas channel and a vacuum valve, wherein the laminating foam structure is attached on a bottom surface of the laminating plate and aligned with the fixing recess, and the sealed chamber is in communication with the at least one gas channel and the vacuum valve, wherein the step (d) comprises steps of:
(d1) opening the vacuum valve and allowing the gas within the sealed chamber to be evacuated through the at least one gas channel, wherein in response to a pressure difference between an external pressure and an inner pressure, the laminating plate is subjected to deformation to press the bottom mold, and the laminating foam structure is moved downwardly to press the covering plate of the fingerprint recognition module; and
(d2) closing the vacuum valve when the sealed chamber reaches the vacuum state.

3. The method according to claim 1, wherein the step (e) comprises a step (e1) of maintaining the vacuum state of the sealed chamber and allowing the fingerprint recognition module in the vacuum lamination device to be baked, so that the glue is cured.

4. The method according to claim 1, wherein after the step (e), the method further comprises a step (f) of removing the fingerprint recognition module from the fixing recess of the vacuum lamination device.

5. The method according to claim 1, wherein before the step (b), the method further comprises a step (b′) of sequentially coating the glue on a top surface of the fingerprint chip and placing the covering plate on the glue.

6. The method according to claim 1, wherein the covering plate is made of a ceramic material or a glass material.

7. A vacuum lamination device for laminating a fingerprint recognition module, the vacuum lamination device comprising:
a top mold comprising a top mold plate and a laminating plate, wherein the laminating plate is connected with the top mold plate; and
a bottom mold movable relative to the top mold, wherein the bottom mold comprises a bottom mold structure, a fixing recess, at least one gas channel and a vacuum valve, wherein the fixing recess is concavely formed in a portion of a top surface of the bottom mold structure for accommodating the fingerprint recognition module, and the at least one gas channel is formed downwardly from another portion of the top surface of the bottom mold structure and in communication with the vacuum valve,
wherein when the top mold and the bottom mold are contacted with each other, a sealed chamber is defined by the top mold and the bottom mold collaboratively, and the sealed chamber is in communication with the vacuum valve through the at least one gas channel.

8. The vacuum lamination device according to claim 7, wherein the laminating plate further comprises a laminating foam structure, and the laminating foam structure is formed on a bottom surface of the laminating plate and aligned with the fixing recess, wherein when the top mold and the bottom mold are contacted with each other and the sealed chamber is in a vacuum state, the laminating plate is subjected to downward deformation and the fingerprint recognition module within the fixing recess is pressed by the laminating foam structure.

9. The vacuum lamination device according to claim 7, wherein the fixing recess is concavely formed in a middle region of the top surface of the bottom mold structure, and the at least one gas channel comprises plural gas channels, wherein the plural gas channels are formed downwardly from a peripheral region of the top surface of the bottom mold structure, the plural gas channels are in communication with the vacuum valve, and the vacuum valve is located at a lateral side of the bottom mold structure.
